(19) United States
(12) Patent Application Publication
(10) Pub. No.: US 2025/0211013 A1
(43) Pub. Date: Jun. 26, 2025

(54) CHARGE DISCHARGE MANAGEMENT DEVICE, CHARGE DISCHARGE SYSTEM, AND STORAGE MEDIUM

(71) Applicant: TOYOTA JIDOSHA KABUSHIKI KAISHA, Toyota-shi (JP)

(72) Inventors: Kento IWAHORI, Nagoya-shi (JP); Yasuhiro SAITO, Toyoake-shi (JP); Daiki YOKOYAMA, Miyoshi-shi (JP)

(73) Assignee: TOYOTA JIDOSHA KABUSHIKI KAISHA, Toyota-shi (JP)

(21) Appl. No.: 18/792,934

(22) Filed: Aug. 2, 2024

(30) Foreign Application Priority Data
Dec. 22, 2023 (JP) 2023-216691

(51) Int. Cl. H02J 7/00; B60L 53/62; B60L 58/13

(52) U.S. Cl. CPC H02J 7/0071; B60L 53/62; B60L 58/13; H02J 7/0048; H02J 2310/48

(57) ABSTRACT

The charge discharge system according to the embodiment includes: an information acquisition unit that acquires production management information regarding at least one of a number of production vehicles per predetermined time and a shipping time limit of a vehicle having a secondary battery; a charge discharge management device that includes a charge discharge amount determining unit that determines a charge discharge amount per unit time to the vehicle based on the production management information; and a charging discharging device that executes a charging rate adjustment processing that includes at least one of a charging process for charging the secondary battery and a discharging process for discharging the secondary battery in accordance with the charge discharge amount.

### CROSS-REFERENCE TO RELATED APPLICATION

This application claims priority to Japanese Patent Application No. 2023-216691 filed on Dec. 22, 2023, incorporated herein by reference in its entirety.

### BACKGROUND

### 1. Technical Field

The present disclosure relates to a charge discharge management device, a charge discharge system, and a storage medium.

### 2. Description of Related Art

Japanese Patent No. 7351427 discloses technology for managing State Of Charge (SOC) of secondary batteries at an appropriate level in a manufacturing process of vehicles using automated driving by remote control. In Japanese Patent No. 7351427, charging rate adjustment processing including at least one of discharging processing for discharging the secondary battery and charging processing for charging the secondary battery is executed by remote control of the vehicle, to bring the charging rate of the secondary battery near to a target value.

### SUMMARY

From a perspective of suppressing deterioration and the like of the secondary battery, it is preferable that the charge rate of the secondary battery is managed at an appropriate value in the manufacturing process of the vehicle. On the other hand, in the manufacturing of vehicles, a count of production units (count of manufactured units) per predetermined time is set. The time required for manufacturing each vehicle (takt time) includes time required for the charging and discharging processing of the secondary battery installed in the vehicle, and accordingly managing the charging and discharging in accordance with the takt time is desirable.

An object of the present disclosure is to provide technology for managing charging and discharging of a secondary battery, taking into consideration information related to production of a vehicle in a manufacturing process of the vehicle.

A charging management device according to an aspect of the present disclosure includes an information acquisition unit that acquires production management information related to production of a vehicle, including at least one of a count of production units per predetermined time, and a shipping time limit, regarding the vehicle including a secondary battery, and a charge discharge amount determining unit that determines a charge discharge amount per unit time of the secondary battery, based on the production management information.

The charging management device further includes an allocation time determining unit that determines an allocation time allocated to charging and discharging of the secondary battery, using the production management information, in which the charge discharge amount determining unit can determine a charge discharge amount per unit time to the vehicle in accordance with the allocation time.

Also, the charge discharge amount when the count of production units is a first count of units may be greater than the charge discharge amount when the number of production units is a second count of units that is smaller than the first count of units.

Also, the charge discharge amount when the shipping time limit is a first time limit may be greater than the charge discharge amount when the shipping time limit is a second time limit that is longer than the first time limit.

A charge discharge system according to an aspect of the present disclosure includes a charge discharge management device that includes an information acquisition unit that acquires production management information related to at least one of a count of production units per predetermined time, and a shipping time limit, regarding a vehicle including a secondary battery, and a charge discharge amount determining unit that determines a charge discharge amount per unit time of the vehicle, based on the production management information, and a charging discharging device that executes charging rate adjustment processing including at least one of charging processing for charging the secondary battery and discharging processing for discharging the secondary battery, according to the charge discharge amount.

In the charge discharge system, the charge discharge management device further includes an allocation time determining unit that determine an allocation time allocated to charging and discharging of the secondary battery, using the production management information, and the charge discharge amount determining unit can determine a charge discharge amount per unit time to the vehicle in accordance with the allocation time.

Also, the charge discharge amount when the count of production units is a first count of units may be greater than the charge discharge amount when the count of production units is a second count of units that is smaller than the first count of units.

Also, the charge discharge amount when the shipping time limit is a first time limit may be greater than the charge discharge amount when the shipping time limit is a second time limit that is longer than the first time limit.

The charging and discharging device may include at least one of a contact-type charging discharging device and a non-contact-type charging discharging device.

When the charging discharging device includes a contact-type charging discharging device and a non-contact-type charging discharging device, a charge discharge amount by the contact-type charging discharging device may be equal for both when the count of production units is a first count of units and when the count of production units is the second count of units that is smaller than the first count of units, and also, the charge discharge amount by the non-contact type charging discharging device may be greater when the count of production units is the first count of units than that when the count of production units is the second count of units.

A storage medium according to an aspect of the present disclosure is a storage medium storing a program causing a computer to execute: processing of acquiring production management information related to at least one of a count of production units per predetermined time, and a shipping time limit, regarding a vehicle including a secondary battery; and processing for determining a charge discharge amount per unit time to the vehicle, based on the production management information.

In a vehicle manufacturing method according to an aspect of the present disclosure, a computer executes processing of acquiring production management information related to at least one of a count of production units per predetermined time, and a shipping time limit, regarding a vehicle including a secondary battery; and processing for determining a charge discharge amount per unit time to the vehicle, based on the production management information.

A vehicle according to an aspect of the present disclosure includes a secondary battery, an information acquisition unit that acquires production management information related to at least one of a count of production units per predetermined time, and a shipping time limit, regarding a vehicle, and a charge discharge amount determining unit that determines a charge discharge amount per unit time of the vehicle, based on the production management information, and an output unit that outputs the charge discharge amount to a charging discharging device that executes charging rate adjustment processing including at least one of charge processing for charging the secondary battery and discharge processing for discharging the secondary battery, in accordance with the charge discharge amount.

According to the present disclosure, technology for managing charging and discharging of a secondary battery, taking into consideration of information related to production of a vehicle in a manufacturing process of the vehicle, is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of a charge discharge system according to a first embodiment;

FIG. 2 is a diagram illustrating a configuration of the charging device of FIG. 1;

FIG. 3 is a diagram illustrating a configuration of the server of FIG. 1;

FIG. 4 is a flowchart illustrating a procedure of a charging and discharging process in the vehicle manufacturing method according to the first embodiment;

FIG. 5 is a diagram illustrating a configuration of a system according to the first embodiment;

FIG. 6 is a flowchart illustrating a procedure of remote control for a vehicle;

FIG. 7 is a flowchart illustrating a procedure of remote control for a vehicle;

FIG. 8 is a diagram illustrating a configuration of a system according to a second embodiment;

FIG. 9 is a diagram illustrating a configuration of vehicles according to a third embodiment; and

FIG. 10 is a flowchart for explaining a processing procedure of travel control of the vehicle.

### DETAILED DESCRIPTION OF EMBODIMENTS

An embodiment of the present disclosure will be described below with reference to the drawings. It should be noted that the disclosure according to the claims is not limited to the following embodiments. Also, not all of the configurations described in the embodiments are indispensable as means for solving the problem. For clarity of explanation, the following description and the drawings are omitted and simplified as appropriate. In the drawings, the same elements are denoted by the same reference numerals, and redundant descriptions are omitted as necessary.

### First Embodiment

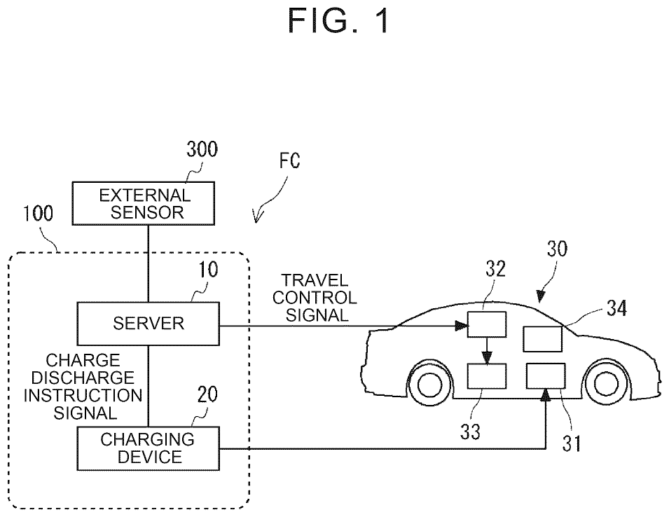

A charge discharge system 100 according to the first embodiment will be described with reference to FIGS. 1 to 3. FIG. 1 is a schematic diagram illustrating an example of a configuration of a charge discharge system 100 according to an embodiment. The charge discharge system 100 is used in a factory FC for manufacturing the vehicles 30. The charge discharge system 100 is used, for example, when a vehicle is manufactured while the vehicle 30 is moved by remote or automatic control.

### Vehicle 30

The vehicle 30 is, for example, a passenger car, a truck, a bus, a two-wheeled vehicle, a four-wheeled vehicle, a tank, a construction vehicle, or the like. Vehicles 30 include Battery Electric Vehicle (BEV), hybrid electric vehicle, and fuel cell electric vehicle. Note that the present disclosure is also applicable to “moving bodies” other than vehicles. “Mobile” means a movable object, for example a vehicle, an electric vertical takeoff and landing machine (so-called flying motor vehicle). The vehicle may be a vehicle traveling by wheels or a vehicle traveling by an infinite track. When the moving body is other than the vehicle, the expressions of “vehicle” and “vehicle” in the present disclosure can be appropriately replaced with “moving body”, and the expression of “traveling” can be appropriately replaced with “moving”.

The vehicle 30 is configured to be able to travel by unmanned driving. The term “unmanned driving” means driving that does not depend on the traveling operation of the passenger. The traveling operation means an operation related to at least one of “running”, “turning”, and “stopping” of the vehicle 30. The unmanned driving is realized by automatic or manual remote control using a device provided outside the vehicle 30, or by autonomous control of the vehicle 30.

Note that a passenger who does not perform the traveling operation may be on the vehicle 30 traveling by the unmanned driving. The passenger who does not perform the traveling operation includes, for example, a person who is simply seated on the seat of the vehicle 30, and a person who performs a work different from the traveling operation such as an assembling operation, an inspection operation, and a switch operation while riding on the vehicle 30. Driving by the traveling operation of the occupant is sometimes referred to as “manned driving”. The embodiment is also applicable to a vehicle 30 traveling by manned driving.

The “remote control” includes “full remote control” in which all of the operations of the vehicle 30 are completely determined from the outside of the vehicle 30, and “partial remote control” in which a part of the operations of the vehicle 30 is determined from the outside of the vehicle 30. Further, “autonomous control” includes “fully autonomous control” in which the vehicle 30 autonomously controls its operation without receiving any information from a device external to the vehicle 30, and “partially autonomous control” in which the vehicle 30 autonomously controls its operation using information received from a device external to the vehicle 30.

The vehicle 30 includes a secondary battery 31, a communication unit 32, an electronic control unit (ECU) 33, and a load device 34. The secondary battery 31 is, for example, a rechargeable traveling battery such as a lithium-ion battery or a nickel-metal hydride battery. The secondary battery 31 can store electric power used for traveling of the vehicle 30. The secondary battery 31 is charged via a power receiver (not shown) conforming to a connector standard corresponding to the charging connector 22 of the charging device 20 described later.

The charge discharge system 100 manages state of charge (hereinafter, referred to as SOC) of the secondary battery 31 mounted on the vehicles 30. When electric power is supplied from the charging device 20 via the power receiver, the secondary battery 31 is charged, and SOC increases.

The communication unit 32 is a wireless communication device, such as a dongle, mounted on the vehicle 30. The communication unit 32 transmits SOC and the like of the secondary battery 31 to the server 10. The communication unit 32 can communicate using, for example, a controller area network (CAN) communication used for control of the vehicles 30. CAN communication is a communication standard that can transmit or receive in multiple directions. The communication unit 32 may further use diagnosis communication. Diagnosis communication is a communication standard in which a request and a response can be associated with each other on a one-to-one basis, and is used for diagnosis of a failure or the like.

ECU 33 is a vehicle control unit that is mounted on the vehicle 30 and executes various kinds of control of the vehicle 30. ECU 33 includes a processor and memories (not shown). When the processor executes the vehicle control program stored in the memory, ECU 33 realizes various functions including functions as the vehicle control unit. ECU 33 functions as, for example, a driving control unit that executes driving control of the vehicles 30 and an auxiliary machine control unit that drives the auxiliary machine.

The “driving control” is, for example, an adjustment of an acceleration, a speed, and a steering angle of the vehicle 30. ECU 33 controls an actuator group mounted on the vehicle 30 in accordance with a travel control signal received from the server 10 via the communication unit 32 for remotely controlling the vehicle 30. The actuator group includes an actuator of a driving device for accelerating the vehicle 30, an actuator of a steering device for changing a traveling direction of the vehicle 30, and an actuator of a braking device for decelerating the vehicle 30. Further, in the charging process, ECU 33 controls the charging of the secondary battery 31 by controlling the power receiver. In the discharge process, ECU 33 controls the discharge of the secondary battery 31 by driving the load device 34.

The load device 34 is connected to the secondary battery 31. The load device 34 includes an auxiliary battery, an auxiliary device, a motor, and the like, which are not illustrated. The auxiliary battery is a battery having a lower voltage than that of the secondary battery 31, which is used for driving the auxiliary device. The auxiliary battery is charged when electric power is supplied from the secondary battery 31.

The auxiliary device is electrically connected to the auxiliary device battery, and is driven by using electric power of the auxiliary device battery. Examples of the auxiliary device include a car audio, an air conditioner, a power window, lights, a door lock, a wiper, a brake, and a car navigation system. Note that the auxiliary device may be driven by using the electric power of the secondary battery 31.

The motor is, for example, an AC synchronous motor, and functions as an electric motor and a generator. When the motor functions as an electric motor, the motor is driven using the electric power stored in the secondary battery 31 as a power source. The output of the motor is transmitted to the wheels via the speed reducer and the axle. When the vehicle 30 decelerates, the motor functions as a generator that utilizes the rotation of the wheels, and generates regenerative electric power. When the regenerative electric power generated by the motor is supplied to the secondary battery 31, the secondary battery 31 is charged and SOC increases.

Incidentally, the factory FC is not limited when it is a single building or when it exists in the site or address of one place, the respective processes in the manufacturing process may exist over a number of buildings, multiple sites, multiple addresses, etc. The phrase “the vehicle 30 travels in the factory FC” includes cases where the vehicle 30 travels between processes existing in a plurality of locations. For example, the present disclosure includes cases where the vehicles 30 are traveling on public roads that exist not only between private roads but also between factory FC in order to move between factory FC that exist in a plurality of locations. Note that, in the following description, a vehicle completed as a product and a vehicle as a semi-finished product and a work-in-process product being manufactured are collectively referred to as a “vehicle 30”.

In general, the charge amount per unit time and the charge loss are proportional to each other when the secondary battery 31 of the vehicle 30 is charged. That is, the larger the amount of charge per unit time, the more extra power is required that does not contribute to the charging of the secondary battery 31. Here, the “charge amount” refers to electric power supplied from the charging device 20 to the secondary battery 31. Therefore, if there is a margin in the manufacturing time of the vehicle 30, it is desirable to slowly charge the secondary battery 31 with a relatively small charge amount. Also in the case of discharging the secondary battery 31, it is desirable to slowly discharge from the viewpoint of suppressing deterioration of the secondary battery 31 and prolonging the life thereof. Here, the “discharge amount” refers to, for example, electric power consumed from the secondary battery 31 by driving the load device 34.

In the manufacturing process of the vehicle 30, the charge discharge system 100 manages the charge discharge of the secondary battery in consideration of the production management information related to the production of the vehicle 30 including the number of production units per predetermined time, the shipping time limit, and the like.

### Charge Discharge System 100

The charge discharge system 100 includes a server 10 and a charging device 20. Note that the charge discharge system 100 may further include an external sensor 300 used for remote control of the vehicle 30 by the server 10. Here, a camera will be described as an example of the external sensor 300. The external sensor 300 is disposed at a position where an image of the traveling road in the factory FC and the traveling vehicles 30 can be captured. Remote control of the vehicle 30 will be described later.

### Charging Device 20

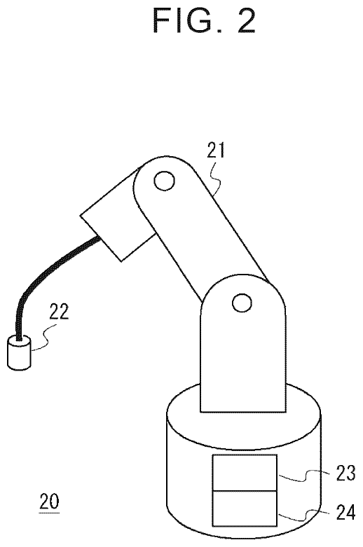

The charging device 20 supplies electric power supplied from an external power source such as a system power source to the vehicle 30. FIG. 2 is a diagram illustrating a configuration of the charging device 20 of FIG. 1. As illustrated in FIG. 2, the charging device 20 is a contact type charging device including a robot arm 21, a charging connector 22, a communication unit 23, and a control unit 24. For example, the charging device 20 can connect the charging connector 22 provided at the distal end of the robot arm 21 to the charging port of the vehicle 30 stopped in the charging/discharging area to supply electric power. The charging from the charging device 20 to the vehicle 30 may be performed through a manual operation by an operator, for example, by manually connecting the charging connector 22 to the vehicle 30.

The communication unit 23 is a communication interface for performing wireless communication with external devices such as the vehicle 30 and the server 10. The control unit 24 controls the charging process to the vehicle 30 based on the charge discharge instruction signal from the server 10. The “charging process” is a process of charging the secondary battery 31 of the vehicle 30 by supplying electric power from the charging device 20 to the secondary battery 31 and increasing SOC of the secondary battery 31.

The “power supply from the charging device 20 to the secondary battery 31” includes a state in which automatic charging can be performed from the charging device 20 to the vehicle 30 under the control of each unit including the robot arm 21 of the charging device 20, and a state in which manual charging can be performed from the charging device 20 to the vehicle 30 by an operator or the like. In the first embodiment, it is assumed that charging from the charging device 20 to the vehicle 30 is automatically performed without moving in a state where the vehicle 30 is stopped in the charging/discharging area. When the manual charging operation by the worker is performed, the charging device 20 may notify the worker of the manual charging operation.

The “discharge process” is a process for discharging the secondary battery 31 to reduce SOC. As the discharge process, since the amount of power consumed when the vehicle 30 is accelerated is large, adjustment of the acceleration of the vehicle 30 is preferable. Further, the discharge process may include power consumption by driving an auxiliary device such as an audio or an air conditioner. When the connection between the motor and the drive wheels can be disconnected, such as when the vehicle 30 includes a clutch, the motor may be discharged by increasing the rotational speed of the motor in a state where the connection between the motor and the drive wheels is disconnected.

When the vehicle 30 includes a transmission, the vehicle 30 may be discharged by increasing the power consumption by switching to a gear ratio that is inefficient with respect to the speed of the vehicle. Note that the discharge of the secondary battery 31 may be performed by a manual discharge operation of discharging the secondary battery 31 manually by an operator, such as an operation of a load device manually by an operator, instead of the above-described discharge process. When the manual discharge operation is performed, the charging device 20 may issue a notification for prompting the operator to perform the manual discharge operation. Note that both the manual discharge operation and the manual charging operation may be performed, or only one of them may be performed.

The control unit 24 includes a computer including a processor (not shown) such as a central processing unit (CPU), and memories (not shown) such as a random access memory (RAM) and a read only memory (ROM). When the processor executes the program stored in the memory, some or all of the functions of the charging device 20 are realized. CPU, the memories, and the communication unit 23 are connected to each other via an internal bus.

### Server 10

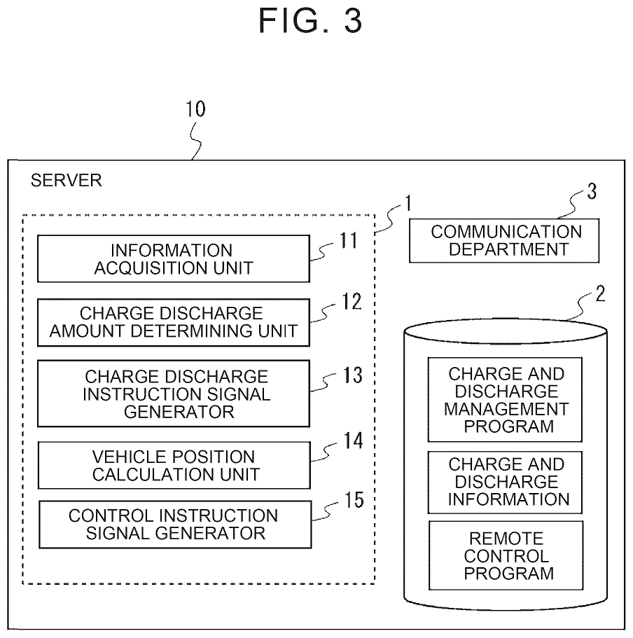

FIG. 3 is a diagram illustrating an internal functional configuration of the server 10 of FIG. 1. The server 10 includes a function of a charge discharge management device that manages charge discharge of a secondary battery in consideration of production management information including the number of production units per predetermined time, a shipping time limit, and the like. As illustrated in FIG. 3, the server 10 includes a processing unit 1, a storage unit 2 (storage medium), and a communication unit 3. The processing unit 1, the storage unit 2, and the communication unit 3 are connected to each other via an internal bus or the like. The storage unit 2 may include a non-volatile storage device such as a hard disk or a flash memory, and a memory such as a RAM, that is, a volatile storage device. The storage unit 2 stores a charge discharge management program, charge discharge information, and a remote control program. Note that the storage unit 2 may store data acquired from the vehicle 30, each process, and the like.

The charge discharge management program is a computer program on which a process of managing charge discharge of the charging device 20 in a process of manufacturing the vehicle 30 is implemented. The charge discharge information indicates the amount of charge per unit time in the “charge process” or the amount of discharge per unit time in the “discharge process”. The storage unit 2 may include a table in which the number of production units and the charge discharge amount per predetermined time of the vehicle 30 are stored in correspondence with each other. That is, if the number of vehicles produced per predetermined time of the vehicle 30 is known, the charge discharge amount in the manufacturing process of the vehicle 30 is determined.

The remote control program is a computer program on which a process of generating a travel control signal for remotely controlling the vehicle 30 is implemented. The communication unit 3 is a communication interface for communicating with the vehicle 30, the charging device 20, and the like via a network.

The processing unit 1 is, for example, a processor such as a CPU, a graphics processing unit (GPU), a field-programmable gate array (FPGA), or a quantum processor (quantum computer-controlled chip). The processing unit 1 causes the memory to read and execute the charge discharge management program stored in the storage unit 2. Thus, the processing unit 1 realizes the functions of the information acquisition unit 11, the charge discharge amount determining unit 12, and the charge discharge instruction signal generation unit 13. These functions are part of the functions of the charge discharge management device.

Further, the processing unit 1 causes the memory to read and execute the remote control program stored in the storage unit 2. Thus, the processing unit 1 realizes the functions of the vehicle position calculation unit 14 and the travel control signal generation unit 15. These functions are part of the function as a remote control device for remotely controlling the vehicle. That is, in the first embodiment, the server 10 has a function as a charge discharge management device and a function as a remote control device that remotely controls the vehicle.

The processing unit 1 may generate and output not only the travel control signal but also a control signal for controlling an actuator for operating various accessories included in the vehicle 30, such as a wiper, a power window, or a lamp. That is, the server 10 may operate the various accessories by remote control. Some or all of the components of the processing unit 1 may be realized by, for example, a general-purpose or dedicated circuit realized by a semiconductor device.

The vehicle position calculation unit 14 acquires a captured image from a camera as the external sensor 300 via the communication unit 3. The vehicle position calculation unit 14 analyzes the captured image at predetermined time intervals to calculate vehicle position information including the position and orientation of the vehicle 30.

The travel control signal generation unit 15 generates a travel control signal for remotely controlling the vehicle 30. The travel control signal is a control signal for causing the vehicle 30 to travel. In the present embodiment, the travel control signal includes the acceleration and the steering angle of the vehicle 30 as parameters. In other embodiments, the travel control signal may include the speed of the vehicle 30 as a parameter in place of or in addition to the acceleration of the vehicle 30. The travel control signal generation unit 15 transmits a travel control signal to the vehicle 30 via the communication unit 3. When the vehicle 30 receives the traveling control signal via the communication unit 32, ECU 33 realizes the driving control. The vehicle position calculation unit 14 can automatically cause the vehicle 30 to travel along the reference route by sequentially adjusting the relative position of the vehicle 30 along the reference route.

Further, the vehicle position calculation unit 14 can determine whether or not the vehicle 30 has stopped in the charging/discharging area by analyzing the captured image. For example, the vehicle position calculation unit 14 can recognize the charge discharge area from the captured image and determine the stop of the vehicle 30 in the charge discharge area based on the change in the position of the vehicle 30 included in the consecutive image frames. It is to be noted that it may be determined whether or not the vehicle 30 has stopped in the charging/discharging area, based on detection signals such as a sensor for detecting the entry of the vehicle 30 into the charging/discharging area, a vehicle speed sensor mounted on the vehicle 30, and a wheel-side sensor. As described above, in the first embodiment, the charging and discharging process of the secondary battery 31 is performed by the charging device 20 in a state in which the vehicle 30 is stopped in the charging and discharging area.

The information acquisition unit 11 acquires information such as the present SOC of the secondary battery 31 mounted on the vehicle 30 from the vehicle 30 via the communication unit 3. SOC can be calculated using, for example, a cell voltage, a current, and a temperature of the secondary battery 31 detected by a sensor (not shown) provided in the vehicle 30, a standard value of the secondary battery 31, and the like. SOC may be estimated from the elapsed time from the time when SOC was previously measured, the traveling time of the vehicle 30, the traveling distance, and the like, instead of the power of the secondary battery 31.

Note that the information acquisition unit 11 is not limited to the present SOC, and can acquire SOC target to be charged from the vehicles 30. SOC target may be input to the server 10 via an input device (not shown). In addition, a SOC target value set in advance for each of the vehicles 30 may be stored in the storage unit 2. SOC target value stored in the storage unit 2 is stored in association with vehicle identification information for identifying the vehicle.

The “vehicle identification information” means various types of information capable of identifying SOC target set for each vehicle 30. The vehicle identification information may include, for example, ID information provided for each vehicle 30, and specification information of the vehicle 30 such as a vehicle type, a color, and a shape of the vehicle 30. When the vehicle 30 can be identified from the “production management information” described later, the production management information may be used as the vehicle identification information.

When a plurality of vehicles 30 having the same SOC target values are manufactured on a group-by-group basis, such as for each lot, a lot number or the like may be used as the vehicle identification information. The vehicle identification information may be time information such as the start time and the completion time of the process in each process of the vehicle 30. Further, the vehicle identification information may be vehicle position information in a factory FC or the like.

SOC target is set according to, for example, a destination country, which is a shipping destination of the manufactured vehicles 30. When transportation is prolonged, for example, when sea mail is used for shipment to a destination country, a SOC target is set considering the effect on the life of the secondary battery 31. For example, SOC target value is set to a value equal to or higher than the lower limit value and equal to or lower than the upper limit value. The lower limit of SOC target value may be set to a lower standard limit (LSL) or higher in order to suppress or prevent degradation of the secondary battery 31 due to SOC degradation. The upper limit of SOC target value may be a value lower than or equal to the upper standard limit (USL) of SOC in order to suppress or prevent degradation of the secondary battery 31 due to overcharge.

When the present SOC is lower than the lower limit value, the charge process is executed so as to be equal to or higher than the lower limit value. When the present SOC is higher than the upper limit value, the discharging process is executed so as to be equal to or lower than the upper limit value. As SOC target value, only one of the lower limit value and the upper limit value may be used. SOC target value is not limited to a numerical value range, and may be set using a particular numerical value. When SOC target value is a particular numerical value, for example, when the present SOC is higher than SOC target value or lower than SOC target value, the charging process or the discharging process is executed so as to approach SOC target value.

The information acquisition unit 11 acquires the production management information related to the production of the vehicle including at least one of the number of production units per predetermined time of the vehicle 30 and the shipping time limit. The “production management information” may include, for example, a start time and a completion time of processing of each process, vehicle identification information of the vehicle 30 existing in each process, and the number of work-in-process items.

The charge discharge amount determining unit 12 can determine the required charge discharge value of the secondary battery 31 by using the acquired SOC and SOC target value. Further, the charge discharge amount determining unit 12 determines the charge discharge amount per unit time of the secondary battery 31 based on the acquired production management information. That is, the charge discharge amount determining unit 12 adjusts the charge discharge conditions such as the charge discharge amount and the charge time at the time of charging to be suitable for the secondary battery 31.

For example, the information acquisition unit 11 may acquire, as the production management information, the production unit number information regarding the production unit number per predetermined time of the vehicle 30. The charge discharge amount determining unit 12 can determine the charge discharge amount by referring to the charge discharge information stored in the storage unit 2 using the production number information.

Note that the charge discharge amount determining unit 12 may have a function of calculating an allocation time allocated to charge discharge of the secondary battery 31. The charge discharge amount determining unit 12 may determine the charge discharge amount per unit time to the secondary battery 31 in accordance with the allocation time allocated to the charge discharge process from the charging device 20 to the secondary battery 31. In this case, the storage unit 2 may include, for example, a table in which the allocation time allocated to the charge discharge process of the vehicle 30 and the charge discharge amount are stored in correspondence with each other.

For example, when the number of production units per predetermined time is 0.1 million, in a case where the time allocated to the charging and discharging process is 120 seconds among a plurality of processes for manufacturing the vehicle 30, and when the number of production units is 0.2 million, the time allocated to the charging and discharging process is 60 seconds. As described above, as the number of production units per predetermined time increases, the allocation time of the charge discharge process becomes shorter. Therefore, when the amount of charge to be charged to each vehicle 30 is the same, the charge discharge amount determining unit 12 can increase the charge discharge amount in the case where the number of production units is the first number, than the charge discharge amount in the case where the number of production units is the second number smaller than the first number.

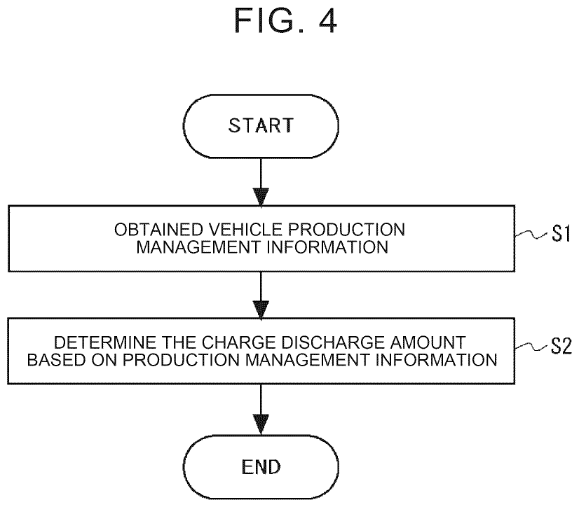

FIG. 4 is a flowchart of a method of manufacturing a vehicle according to the embodiment. A method of manufacturing a vehicle according to an embodiment will be described with reference to FIG. 4. The vehicle manufacturing method according to the embodiment includes a charging and discharging process of the secondary battery 31 using the charge discharge system 100. After the vehicle 30 is assembled in the factory FC, the vehicle 30 is remotely controlled in accordance with the travel control signal, travels to the charge discharge area, and is stopped. First, the server 10 acquires the production management information (S1).

After that, the server 10 determines the charge discharge amounts based on the production management information (S2). As a result, in the manufacturing process of the vehicle 30, the optimum charging and discharging can be performed with the charge discharge amount determined in consideration of the production management information of the vehicle 30. Note that the information acquisition unit 11 may acquire, as the production management information, time information (takt time information) required for manufacturing per vehicle. The charge discharge amount determining unit 12 can also determine the amount of charge to the vehicle 30 using the takt time information.

In addition, the charge discharge system 100 may manage the charging/discharging in place of or in addition to the above-described production number information in consideration of the shipping time limit information regarding the shipping time limit of the vehicle. For example, the closer the shipping time limit is, the shorter the allocation time of the charge discharge process becomes. When the shipping time limit is the first time limit and the second time limit that is farther than the first time limit is compared with each other, the charge discharge amount determining unit 12 can increase the time that the second time limit takes for the charge discharge process more than the first time limit. In this case, the charge discharge amount determining unit 12 can set the charge discharge amount in the case where the shipping time limit is the first time limit to be larger than the charge discharge amount in the case where the shipping time limit is the second time limit that is farther than the first time limit.

The charge discharge instruction signal generation unit 13 generates a charge discharge instruction signal based on the charge discharge amount determined by the charge discharge amount determining unit 12, and transmits the charge discharge instruction signal to the charging device 20. The charging device 20 can execute the charging/discharging process of the secondary battery 31 of the vehicle 30 with the charge discharge amount corresponding to the charge discharge instruction signal.

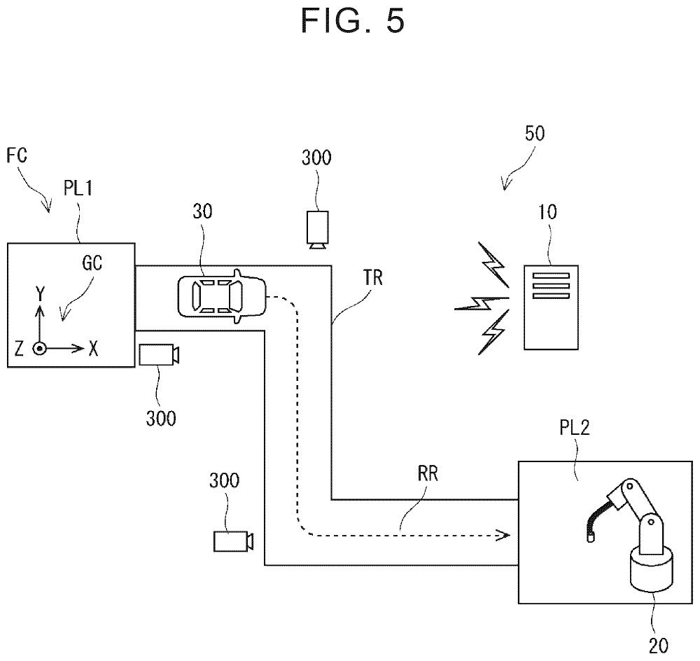

Next, the remote control of the vehicle 30 by the server 10 will be described with reference to FIG. 5. FIG. 5 is a diagram illustrating a configuration of a system 50 according to the first embodiment. In the embodiment illustrated in FIG. 5, the “remote control” includes a control of causing the vehicle 30 to travel along a referred route in the factory FC, and a control of charging and discharging the secondary battery 31 of the vehicle 30 by the charging device 20 in the charging and discharging area.

The reference coordinate system of the factory FC shall be the global coordinate system GC. That is, any position in the factory FC is represented by coordinates of X, Y, and Z in the global coordinate system GC. The factory FC includes a preceding process area PL1 and a charge and discharge area PL2. The preceding process area PL1 and the charge and discharge area PL2 are connected by a track TR on which the vehicles 30 can travel. In the factory FC, a plurality of external sensors 300 is installed along the track TR.

The external sensors 300 are sensors located outside the vehicle 30. The external sensors 300 in the first embodiment are sensors that captures the vehicle 30 from the outside of the vehicle 30. The external sensors 300 include a communication device (not shown), and can communicate with another device such as the server 10 by wired communication or wireless communication. The positions of the external sensors 300 in the factory FC are adjusted in advance. Here, it is assumed that the vehicles 30 move from the preceding process area PL1 to the charge and discharge area PL2 through the track TR by unmanned driving.

In the preceding process area PL1, for example, an assembly process of assembling a component to a vehicle body is performed. Note that the preceding process area PL1 is not limited to the assembly process, and any manufacturing process may be used as long as the vehicles 30 after the process by the pre-process can travel by remote control.

The vehicles 30 after the processing by the pre-process travel from the preceding process area PL1 to the charge and discharge area PL2 through the track TR. The charging device 20 is installed in the charge and discharge area PL2. In the charge and discharge area PL2, the charging process and the discharging process of the secondary battery 31 of the vehicles 30 by the charging device 20 are automatically executed.

The camera is an example of the external sensor 300 located outside the vehicle 30. The camera as the external sensor 300 captures a captured image including the vehicle 30, and outputs the captured image as a detection result. For example, images of the vehicles 30 on the track TR viewed from above are acquired. The number of cameras is set to a number that allows the entire track TR to be imaged, taking into account the angle of view of the camera and the like. Note that the camera is not limited to an image from above the vehicle 30, and an image from the front, rear, side, or the like of the vehicle 30 may be acquired. In addition, cameras for acquiring these images may be arbitrarily combined. With such a configuration, the vehicle 30 can be automatically driven by remote control without using a detector mounted on the vehicle 30 such as a camera, a millimeter-wave radar, or a LiDAR. In order to suppress collision during remote control, a detector mounted on the vehicle 30 may be used in an auxiliary manner.

In the track TR, a reference route RR to be traveled by the vehicles 30 is set in advance. The server 10 causes ECU 33 to execute the driving control of the vehicle 30 while analyzing images of the track TR and the vehicle 30 acquired by the camera at predetermined time-intervals. By sequentially adjusting the relative position of the vehicle 30 with respect to the reference route RR by the server 10, the vehicle 30 can travel along the reference route RR. Note that an image of the entire vehicle 30 may be used for remote control, and an image of a part of the vehicle 30, such as an alignment mark provided in the vehicle 30, may be used.

The server 10 causes the vehicle 30 to travel to the charge and discharge area PL2 by remote control so that the vehicle 30 can be charged. When the vehicles 30 reach the charge and discharge area PL2, the charging and discharging process of the secondary battery 31 is performed. The server 10 acquires, for each vehicle 30, the present SOC and SOC target of the secondary battery 31 of the vehicle 30. The server 10 can determine the required charge discharge values by using the present SOC of the secondary battery 31 and SOC target values.

Further, the server 10 acquires production management information including the number of production units per predetermined time. The server 10 can generate a charge discharge instruction signal by obtaining a charge amount per unit time supplied from the charging device 20 to the secondary battery 31 using the required charge discharge value and the production management information. The charge discharge instruction signal is output to the charging device 20 via the communication unit 3. The charging device 20 performs a charging process on the vehicles 30 stopping in the charge and discharge area PL2 in response to the charging/discharging instruction signal.

Specifically, in a case where the number of production units per predetermined time is small, the amount of charge per unit time can be made smaller than in a case where the number of production units per predetermined time is large. That is, in a case where the takt time is long, the amount of charge per unit time is made smaller than in a case where the takt time is short. As described above, as the time allocated to the charge discharge process is longer, the charge loss can be reduced by slowly charging the battery. In addition, when the time allocated to the charge discharge process is short, the charge amount per unit time can be increased, and the charge time can be shortened to adapt to the short takt time.

When the discharge process is executed, the vehicle 30 drives the load device 34 in response to the discharge instruction signal to consume the power of the secondary battery 31. Incidentally, by turning on the auxiliary equipment such as the audio and the air conditioner while the vehicle 30 is traveling, the power of the secondary battery 31 may be consumed more than during normal traveling.

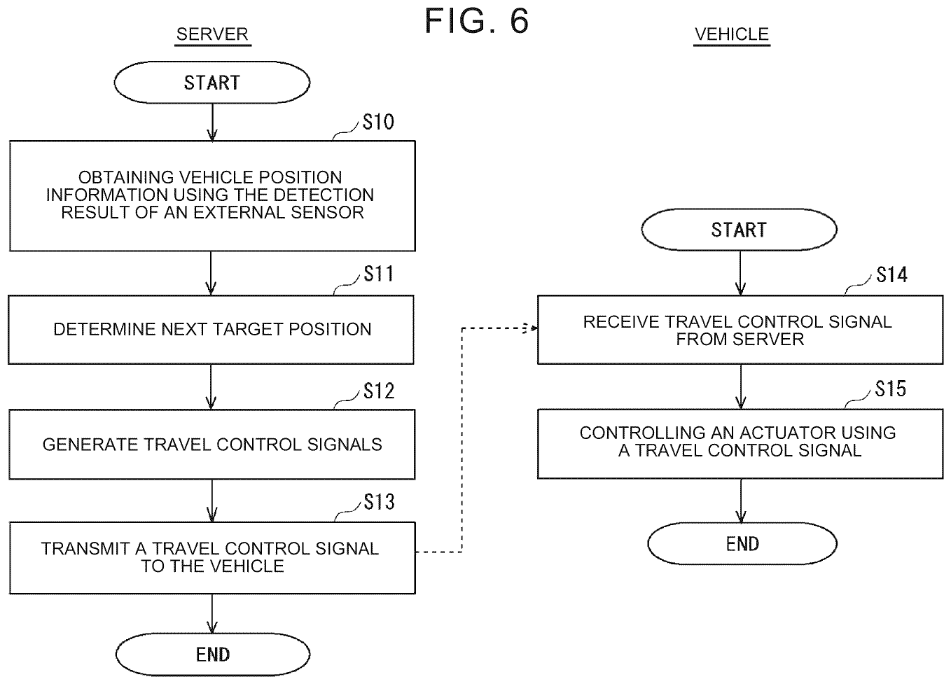

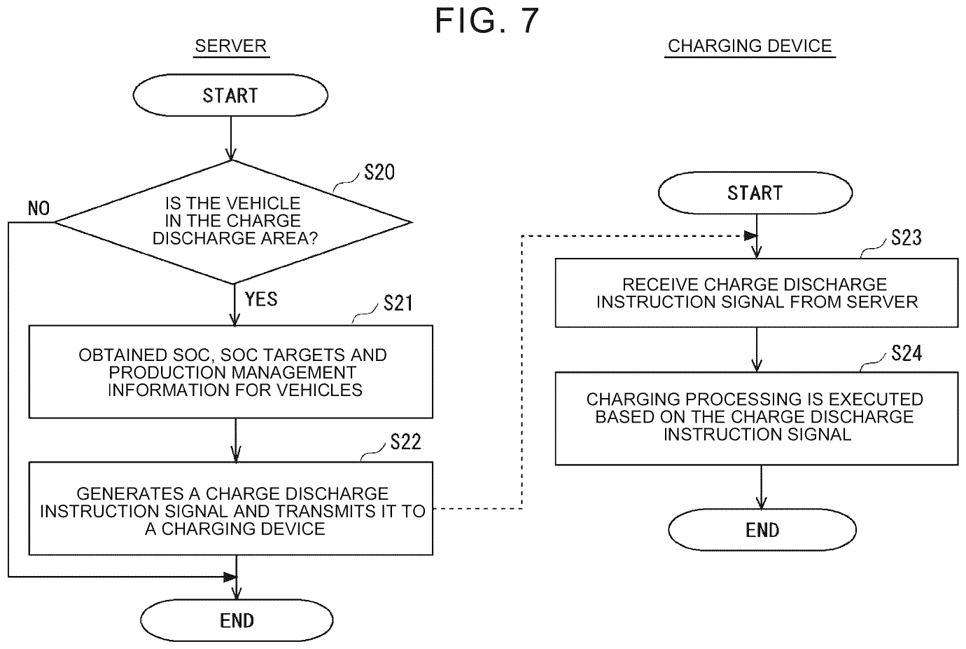

FIG. 6 and FIG. 7 are flowcharts for describing processing procedures of remote control of the vehicle 30 during a manufacturing process of the vehicle 30 according to the first embodiment. In the processing procedures of FIGS. 6 and 7, the processor of the server 10 implements the functions of the processing unit 1 described above by executing the charge discharge management program. ECU 33 of the vehicle 30 functions as a vehicle control unit by executing a vehicle control program. FIG. 6 shows a process sequence of travel control for causing the vehicles 30 to travel along a referred route in the factory FC.

In S10, the processor of the server 10 acquires the vehicle position information of the vehicle 30 using the detection result outputted from the external sensors 300. The vehicle position information is position information that is a basis for generating a travel control signal. In the present embodiment, the vehicle position information includes the position and orientation of the vehicle 30 in the global coordinate system GC of the factory FC. Specifically, in S10, the processor acquires vehicle-position data using captured images acquired from cameras that are the external sensors 300.

Specifically, in S10, the processor acquires the position of the vehicle 30 by, for example, detecting the external shape of the vehicle 30 from the captured image, calculating the coordinate system of the captured image, that is, the coordinates of the positioning point of the vehicle 30 in the local coordinate system, and converting the calculated coordinates into the coordinates in the global coordinate system GC.

The outline of the vehicle 30 included in the captured image can be detected by inputting the captured image into a detection model DM using artificial intelligence, for example. The detection model DM is prepared in the system 50 or outside the system 50, for example, and stored in the storage unit 2 of the server 10 in advance. The detection model DM may be, for example, a learned machine learning model learned to implement either semantic segmentation or instance segmentation. As the machine learning model, for example, a convolutional neural network (hereinafter, CNN) learned by supervised learning using a learning dataset can be used. The training data set includes, for example, a plurality of training images including the vehicle 30, and a label indicating which of an area indicating the vehicle 30 and an area indicating other than the vehicle 30 each area in the training image is. When CNN is learned, the parameters of CNN are preferably updated by back propagation so as to reduce the error between the output-result and-label due to the detection model DM. Further, the processor, for example, by utilizing the optical flow method, by estimating based on the orientation of the movement vector of the vehicle 30 calculated from the positional change of the minutiae of the vehicle 30 between the frames of the captured image, the direction of the vehicle 30 can be obtained.

In S11, the processor of the server 10 determines the target position to which the vehicles 30 are to be headed next. In the present embodiment, the target position is represented by coordinates of X, Y, and Z in the global coordinate system GC. The storage unit 2 of the server 10 stores in advance a reference route RR that is a route on which the vehicle 30 should travel. The route is represented by a node indicating a starting point, a node indicating a passing point, a node indicating a destination, and a link connecting the respective nodes. The processor uses the vehicle position information and the reference route RR to determine a target position to which the vehicle 30 is to be directed next. The processor determines the target position on the reference route RR ahead of the current position of the vehicle 30.

In S12, the processor of the server 10 generates a travel control signal for causing the vehicle 30 to travel toward the determined target position. The processor calculates the traveling speed of the vehicle 30 from the transition of the position of the vehicle 30, and compares the calculated traveling speed with the target speed. Overall, the processor determines the acceleration so that the vehicle 30 accelerates when the traveling speed is lower than the target speed, and determines the acceleration so that the vehicle 30 decelerates when the traveling speed is higher than the target speed. Further, when the vehicle 30 is located on the reference route RR, the processor determines the steering angle and the acceleration so that the vehicle 30 does not deviate from the reference route RR, and determines the steering angle and the acceleration so that the vehicle 30 returns to the reference route RR when the vehicle 30 is not located on the reference route RR, in other words, when the vehicle 30 deviates from the reference route RR.

In S13, the processor of the server 10 transmits the generated travel control signals to the vehicles 30. The processor repeats the acquisition of the position of the vehicle 30, the determination of the target position, the generation of the travel control signal, the transmission of the travel control signal, and the like at predetermined intervals.

In S14, the processor of the vehicle 30 receives the travel control signal transmitted from the server 10. In 515, the processor of the vehicle 30 controls the actuator group using the received travel control signal to cause the vehicle 30 to travel at the accelerations and steering angles represented by the travel control signal. The processor of the vehicle 30 repeatedly receives the travel control signal and controls the actuator group at a predetermined cycle. According to the system 50 of the present embodiment, the vehicle 30 can be driven by remote control, and the vehicle 30 can be moved without using a conveyance facility such as a crane or a conveyor. Even when the charging device 20 is disposed at a position away from the track TR, the charging process of the vehicle 30 can be simplified by automating the moving of the vehicle 30 to the charging device 20.

FIG. 7 shows a processing procedure of control for charging and discharging the secondary battery 31 of the vehicle 30 by the charging device 20 in the charging and discharging area. As illustrated in FIG. 7, first, it is determined whether or not the vehicles 30 are in the charge and discharge area PL2 (S20). When the vehicles 30 are not in the charge and discharge area PL2 (S20, NO), the charge discharge process ends. When the vehicle 30 is in the charge and discharge area PL2 (S20, YES), the server 10 acquires the present SOC, SOC target value and the production management information of the vehicle 30 (S21). The server 10 can acquire the present SOC of the secondary battery 31 mounted on the vehicle 30 from the vehicle 30. Note that the server 10 may repeatedly acquire the present SOC at predetermined intervals, for example, every few seconds, while the vehicles 30 are traveling. The present SOC may be acquired only at predetermined timings, for example, at the time of payout from the previous process. Further, for example, the server 10 can acquire vehicle identification information from the vehicle 30 and acquire SOC target values corresponding to the vehicle identification information from the storage unit 2.

Then, the server 10 generates a charge discharge instruction signal and transmits the charge discharge instruction signal to the charging device 20 (S22). Specifically, the server 10 compares the obtained present SOC with SOC target value, and calculates the required charge discharge value of the secondary battery 31. Then, the server 10 can determine the charge discharge amount by using the determined required charge discharge value and the production management information, and generate a travel control signal for the charging device 20. As described above, as the number of production units per predetermined time increases, the charge discharge amount per unit time can be increased. In addition, the shorter the shipping time limit, the larger the charge discharge amount per unit time. Note that the charge discharge amount per unit time may be determined in consideration of both the number of units produced per predetermined time and the shipping time limit.

The charge discharge travel control signal indicates which of a discharge process of discharging the secondary battery 31 by remote control of the vehicle 30 and a charge process of charging the secondary battery 31 by remote control of the charging device 20 is executed. If the present SOC is greater than the upper limit of SOC target value, a discharging process is performed (not shown in FIG. 7). In this case, for example, the vehicle 30 can drive the mounted load device 34 to consume the electric power stored in the secondary battery 31. For example, the vehicle 30 turns on the audio, the air conditioner, and the like in response to the charge discharge instruction signal. Further, the server 10 may adjust the power consumption by adjusting the volume of the audio, the temperature of the air conditioner, and the like.

When the present SOC is smaller than the lower limit of SOC target value, the charge process is executed. The charging device 20 receives a charge discharge instruction from the server 10 (S23). Then, the charging device 20 performs a charging process based on the charge discharge instruction signal (S24). As a result, as the time allocated to the charge discharge process is longer, the charge loss can be reduced by slowly charging the battery. In addition, when the time allocated to the charge discharge process is short, the charge amount per unit time can be increased, and the charge time can be shortened to adapt to the short takt time.

### Second Embodiment

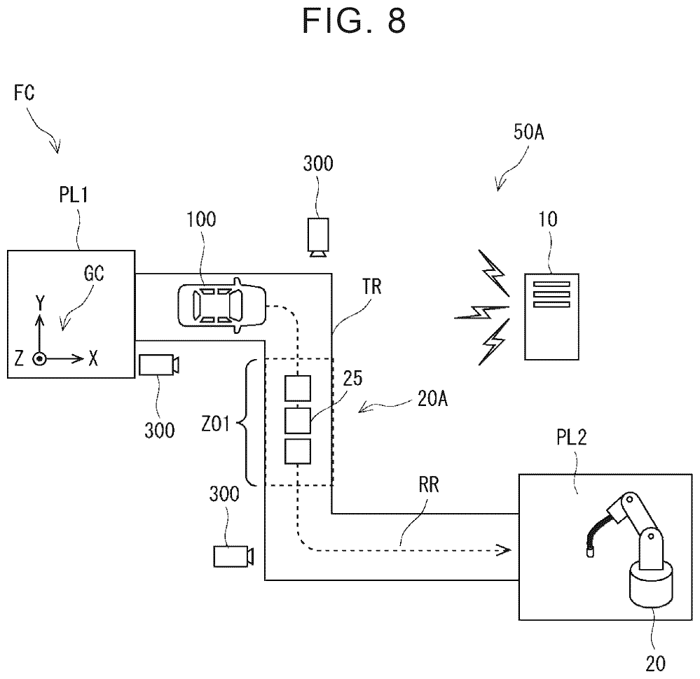

FIG. 8 is a diagram illustrating a configuration of a system 50A according to a second embodiment; The system 50A according to the second embodiment is different from the first embodiment in that a non-contact-type charging device 20A is provided on the track TR between the preceding process area PL1 and the charge and discharge area PL2. That is, 50A of the second embodiment includes both the contact-type charging device 20 and the non-contact-type charging device 20A. Note that, in the second embodiment, the configuration other than the charging device 20A is the same as that of the first embodiment, and therefore, the explanation thereof will be omitted as appropriate.

In the embodiment shown in FIG. 8, the charging device 20A is configured to transmit (provide) power to vehicles 30 traveling or stopping on the track TR. Power is supplied to the charging device 20A from an external power source such as a system power source. The charging device 20A includes a plurality of power feeding coils 25 arranged side by side along the track TR. The section in which the plurality of power feeding coils 25 is installed in the track TR is specified as the power feeding section ZO1 as indicated by hatching in FIG. 1. Note that the charging device 20A may be laid over not only a part of the track TR but also the entire track.

The charging device 20A is configured to non-contact supply electric power from the power feeding coils 25 to a power reception coil (not shown) provided in the vehicle 30 using, for example, a magnetic field resonance system. The plurality of feeding coils 25 is typically installed in the vicinity of the road surface of the track TR. However, the plurality of feeding coils 25 may be installed along the track TR above or on the side of the track TR. In addition, the charging device 20A is not limited to the magnetic field resonance method, and various methods of transmitting power in a non-contact manner, such as an electromagnetic induction method, can be adopted.

The charging device 20A receives a charge discharge instruction from the server 10. The charging device 20A controls the electric power supplied from the power feeding coils 25 to the power receiving coil of the vehicle 30 based on the charge discharge instruction signal. The charging device 20A includes a processor and a storage device (not shown). The storage device stores a program for controlling the power supplied from the power feeding coils 25. The processor of the charging device 20A reads the program and executes the program, thereby realizing a process of controlling the power supplied from the power feeding coils 25.

A process of charging and discharging the secondary battery 31 of the vehicle 30 according to the second embodiment will be described with reference to FIG. 8. When the vehicle 30 approaches within a predetermined range of the charging device 20A, the server 10 acquires the vehicle identity of the vehicle 30. As described above, the server 10 can acquire the corresponding SOC targets using the vehicle-identification information. The server 10 generates the charge discharge instruction signal using SOC target value, the present SOC of the secondary battery 31, and the production management information. The server 10 transmits the generated charge discharge instruction signal to the charging device 20A and the charging device 20.

In the second embodiment, the server 10 can determine the charge amount by the charging device 20 and the charge amount by the charging device 20A so that the secondary battery 31 has the required charge value. Therefore, as described above, the charge discharge instruction signal indicates whether the discharge process or the charge process is executed, and also indicates the charge amounts of the charging device 20 and the charging device 20A. When the vehicle 30 travels on the track TR and enters the power feeding section ZO1, the charging device 20A can perform a charging process on the secondary battery 31 in accordance with the received charging/discharging instruction signal.

In general, the contact-type charging device 20 can more efficiently charge the secondary battery 31 than the non-contact-type charging device 20A. For this reason, in both the case where the number of manufactured units per predetermined time is the first number and the case where the number of manufactured units is the second number that is smaller than the first number, it is preferable that the charge discharge amount by the contact-type charging device 20 be equal, and in the case where the number of manufactured units is the first number, it is preferable that the charge discharge amount by the non-contact-type charging device 20A be larger than that in the case where the number of manufactured units is the second number.

For example, the charging process by the contact-type charging device 20 is executed by the maximum supplied power of the charging device 20 regardless of the number of production units per predetermined period, and the charging process by the non-contact-type charging device 20A can be executed such that the charge discharge amounts increase as the number of production units increases. That is, it is possible to minimize the charging process by the inefficient non-contact power supply. Thus, for example, when the number of units produced per predetermined period of time is large, even when the required power supply value of the secondary battery 31 is high, it is possible to increase the possibility of reducing the power loss due to the non-contact type charging device 20A which is less efficient than the contact-type charging device 20 in general.

In the embodiment illustrated in FIG. 8, the charging device 20A is provided between the preceding process area PL1 and the charge and discharge area PL2. That is, the non-contact power supply by the charging device 20A is performed prior to the contact power supply by the charging device 20. However, the arrangement of the charging device 20A and the charging device 20 is not limited to this example. For example, the non-contact-type charging device 20A may be provided between the charge and discharge area PL2 and a subsequent process area (not shown). That is, the non-contact power supply by the charging device 20A may be executed after the contact power supply by the charging device 20.

According to the second embodiment, as in the first embodiment, it is possible to manage the charging and discharging of the secondary battery in consideration of the information related to the production of the vehicle 30 in the manufacturing process of the vehicle 30. In the second embodiment, the charging process by the charging device 20A can be performed while the vehicles 30 are traveling in the power feeding section ZO1. That is, the charging from the charging device 20A to the vehicle 30 can be automatically performed without the vehicle 30 moving to a different location than the other track TR. “During traveling of the vehicle 30” means a state in which the vehicle 30 is positioned on the track TR for traveling, and includes not only a state in which the vehicle 30 is traveling at any velocity greater than zero, but also a state in which the vehicle is stopped on the track TR.

As described above, the time taken for the charging process by the charging device 20, which is executed when the vehicle 30 is stopped in the charge and discharge area PL2, can be shortened by performing the charging process on the vehicle 30 traveling from the preceding process area PL1 to the charge and discharge area PL2 by the remote control by the charging device 20A. This makes it possible to efficiently perform the charging process of the secondary battery 31. Therefore, SOC of the secondary battery 31 can be adjusted to a predetermined level while suppressing or preventing a decrease in the productivity of the vehicles 30.

Note that the non-contact-type charging device 20A is not limited to a part or all of the track TR, and may be installed at a position different from the track TR. In this case, the charging is automatically performed by moving the vehicle 30 to a position where the charging device 20A is provided by remote control. In addition, the charging device 20A may be provided in an area where other manufacturing processes are performed. That is, the charging/discharging process by the charging device 20A can be performed simultaneously during the other manufacturing process.

### Third Embodiment

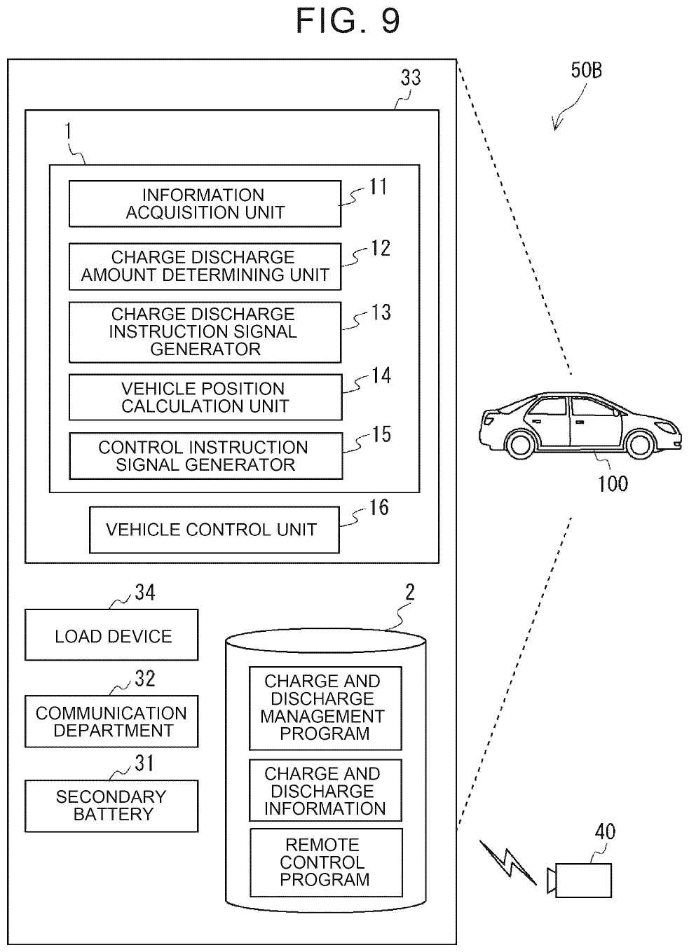

FIG. 9 is a diagram illustrating a schematic configuration of a system 50B including the vehicles 30 according to the third embodiment. In the third embodiment, the server 10 is not provided outside the vehicle 30, and the vehicle 30 itself has the function of the processing unit 1 of the server 10. In FIG. 9, the same functions as those of the server 10 in FIG. 3 are denoted by the same reference numerals. In the example illustrated in FIG. 9, the vehicle 30 can travel by autonomous control.

ECU 33 implements the functions of the information acquisition unit 11, the charge discharge amount determining unit 12, and the charge discharge instruction signal generation unit 13 of the processing unit 1 by executing the charge discharge managing program stored in the storage unit 2. ECU 33 implements the functions of the vehicle position calculation unit 14 and the travel control signal generation unit 15 by executing the vehicle control program. ECU 33 further includes a vehicle control unit 16. The vehicle control unit 16 causes the vehicle 30 to travel by autonomous control by operating the actuator group of the vehicle 30 based on the travel control signal generated by the travel control signal generation unit 15. In addition to the above-described programs, the storage unit 2 stores detection model DM and reference route RR in advance.

The vehicles 30 can transmit the generated charge discharge instruction signal to, for example, the charging device 20 of FIG. 5, the charging device 20 of FIG. 8, and the charging device 20A. When the charging device 20 receives the charge discharge instruction signal, it can perform the charging process with the charge amount determined based on the production management information when the vehicle 30 is stopped in the charge and discharge area PL2. Further, the charging device 20A can perform the charging process with the charge quantity determined based on the production management information when the vehicles 30 are traveling or stopping in the power feeding section ZO1.

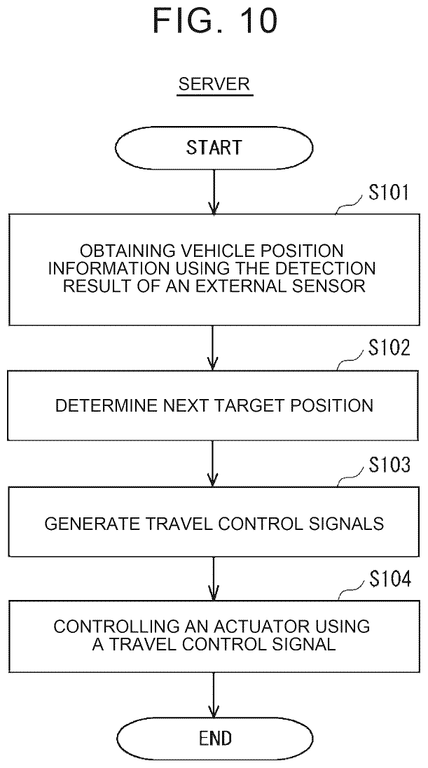

FIG. 10 is a flowchart illustrating a processing procedure of travel control of the vehicle 30 according to the third embodiment. In the process of FIG. 10, ECU 33 of the vehicle 30 functions as the vehicle position calculation unit 14, the travel control signal generation unit 15, and the vehicle control unit 16 by executing the travel control program. In S101, ECU 33 acquires the position information of the vehicle by using the detection result outputted from the cameras as the external sensor 300. At S102, ECU 33 determines the target position to which the vehicles 30 should be heading next. In S103, ECU 33 generates a travel control signal for causing the vehicles 30 to travel toward the determined target position. In S104, ECU 33 controls the actuator group 120 by using the generated travel control signal, thereby causing the vehicles 30 to travel in accordance with the parameters represented by the travel control signal. ECU 33 repeats acquiring the vehicle position information, determining the target position, generating the travel control signal, and controlling the actuator at a predetermined cycle.

According to the third embodiment, even if the server 10 does not remotely control the vehicle 30, the charging device 20, or the charging device 20A, the vehicle 30 can be caused to travel by autonomous control of the vehicle 30, and the charging and discharging of the secondary battery 31 can be managed in view of the production-related information of the vehicle 30.

### Other Embodiments

(XX1) In the first embodiment, a non-contact type charging device 20A may be provided in place of the contact-type charging device 20 in the charge and discharge area PL2. The non-contact type charging device 20A may perform a charging/discharging process based on the charging/discharging instruction signal on the vehicles 30 stopped in the charge and discharge area PL2. Further, in the second embodiment, the charging device 20 may not be provided in the charge and discharge area PL2, and only the charging device 20A may be provided in the track TR. The charge discharge system 100 may include at least one of the contact-type charging device 20 and the non-contact-type charging device 20A, and may include both of them.

(XX2) In the embodiment, an example has been described in which the server 10 generates a charge discharge control signal capable of executing both the discharge process and the charge process. On the other hand, the server 10 may generate a signal capable of executing either the discharging process or the charging process.

(XX3) All or a part of the functions of the information acquisition unit 11, the charge discharge amount determining unit 12, the charge discharge instruction signal generation unit 13, the vehicle position calculation unit 14, and the travel control signal generation unit 15 described above may be provided in the server 10 or a device other than the vehicle 30.

(YY1) In each of the above embodiments, the external sensors 300 are a camera. On the other hand, the external sensors 300 may not be a camera, and may be, for example, a light detection and ranging (LiDAR). In this case, the detection result output by the external sensors 300 may be three-dimensional point cloud data representing the vehicle 30. In this case, the server 10 or the vehicle 30 may acquire the vehicle position information by template matching using three-dimensional point cloud data as a detection result and reference point cloud data prepared in advance.

(YY2) In the first embodiment, the server 10 executes processing from acquisition of vehicle position information to generation of a travel control signal. On the other hand, at least a part of the processing from the acquisition of the vehicle position information to the generation of the travel control signal may be executed by the vehicle 30. For example, the following forms (1) to (3) may be used.

(1) The server 10 may acquire the vehicle position information, determine a target position to which the vehicle 30 should be directed next, and generate a route from the current position of the vehicle 30 to the target position represented by the acquired vehicle position information. The server 10 may generate a route to a target position between the current location and the destination, or may generate a route to the destination. The server 10 may transmit the generated route to the vehicle 30. The vehicle 30 may generate a travel control signal so that the vehicle 30 travels on the route received from the server 10, and control the actuator group using the generated travel control signal.

(2) The server 10 may acquire the vehicle position information and transmit the acquired vehicle position information to the vehicle 30. The vehicle 30 may determine a target position to which the vehicle 30 should be directed next, generate a route from the current position of the vehicle 30 represented in the received vehicle position information to the target position, generate a travel control signal so that the vehicle 30 travels on the generated route, and control the actuator group using the generated travel control signal.

(3) In the above forms (1) and (2), an internal sensor may be mounted on the vehicle 30, and a detection result output from the internal sensor may be used for at least one of generation of a route and generation of a travel control signal. The internal sensor is a sensor mounted on the vehicle 30. The internal sensor may include, for example, a sensor that detects a motion state of the vehicle 30, a sensor that detects an operation state of each unit of the vehicle 30, and a sensor that detects an environment around the vehicle 30.

Specifically, the inner sensor may include, for example, a camera, a LiDAR, a millimeter-wave radar, an ultrasonic sensor, a GPS sensor, an accelerometer, a gyroscope, and the like. For example, in the form (1), the server 10 may acquire the detection result of the internal sensor and reflect the detection result of the internal sensor in the path when generating the path. In the form (1), the vehicle 30 may acquire the detection result of the internal sensor and reflect the detection result of the internal sensor in the travel control signal when generating the travel control signal. In the form (2), the vehicle 30 may acquire the detection result of the internal sensor and reflect the detection result of the internal sensor in the path when generating the path. In the form (2), the vehicle 30 may acquire the detection result of the internal sensor and reflect the detection result of the internal sensor in the travel control signal when generating the travel control signal.

(YY3) In the third embodiment, an internal sensor may be mounted in the vehicle 30, and a detection result output from the internal sensor may be used for at least one of generation of a route and generation of a travel control signal. For example, the vehicle 30 may acquire the detection result of the internal sensor and reflect the detection result of the internal sensor on the route when generating the route. The vehicle 30 may acquire the detection result of the internal sensor and reflect the detection result of the internal sensor in the travel control signal when generating the travel control signal.

(YY4) In the third embodiment, the vehicle 30 acquires the vehicle position information using the detection result of the external sensors 300. On the other hand, an internal sensor is mounted on the vehicle 30, and the vehicle 30 may acquire the vehicle position information using the detection result of the internal sensor, determine the target position to which the vehicle 30 should be directed next, generate a route from the current position of the vehicle 30 represented in the acquired vehicle position information to the target position, generate a travel control signal for traveling the generated route, and control the actuator group using the generated travel control signal. In this case, the vehicle 30 can travel without using any detection result of the external sensors 300. Note that the vehicle 30 may acquire the target arrival time and the traffic jam information from the outside of the vehicle 30 and reflect the target arrival time and the traffic jam information on at least one of the route and the travel control signal. In addition, all the functional configurations of the system 50B may be provided in the vehicles 30. That is, the process implemented by the system 50B may be implemented by the vehicles 30 alone.

(YY5) In the first embodiment, the server 10 automatically generates a travel control signal to be transmitted to the vehicle 30. On the other hand, the server 10 may generate a travel control signal to be transmitted to the vehicle 30 in accordance with an operation of an external operator located outside the vehicle 30. For example, an external operator may operate a control device including a display for displaying captured images output from the external sensors 300, a steering for remotely controlling the vehicle 30, an accelerator pedal, a brake pedal, and a communication device for communicating with the server 10 through wired communication or wireless communication, and the server 10 may generate a travel control signal corresponding to an operation applied to the control device.

(YY6) In each of the above-described embodiments, the vehicle 30 may have a configuration that can be moved by unmanned driving, and may be, for example, in the form of a platform having a configuration described below. Specifically, the vehicle 30 may include at least a vehicle control device and an actuator group in order to perform three functions of “running,” “turning,” and “stopping” by unmanned driving. When the vehicle 30 acquires information from the outside for unmanned driving, the vehicle 30 may further include a communication device. That is, in the vehicle 30 that can be moved by the unmanned driving, at least a part of the interior components such as the driver's seat and the dashboard may not be mounted, at least a part of the exterior components such as the bumper and the fender may not be mounted, and the body shell may not be mounted. In this case, the remaining components such as the body shell may be mounted on the vehicle 30 until the vehicle 30 is shipped from the factory FC, or the remaining components such as the body shell may be mounted on the vehicle 30 after the vehicle 30 is shipped from the factory FC while the remaining components such as the body shell are not mounted on the vehicle 30. Each component may be mounted from any direction, such as the upper side, lower side, front side, rear side, right side or left side of the vehicle 30, each may be mounted from the same direction, each may be mounted from a different direction. It should be noted that the position determination can also be performed for the form of the platform in the same manner as the vehicle 30 in the first embodiment.

(YY7) The vehicle 30 may be manufactured by combining a plurality of modules. The module means a unit composed of a plurality of components arranged in accordance with a part or a function of the vehicle 30. For example, the platform of the vehicle 30 may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. In addition to or instead of the components constituting the platform, the components constituting a part of the vehicle 30 different from the platform may be modularized. Further, the various modules may include any exterior parts such as bumpers and grills, and any interior parts such as sheets and consoles. In addition, not only the vehicle 30 but also a moving object of an arbitrary mode may be manufactured by combining a plurality of modules. Such a module may be manufactured, for example, by joining a plurality of parts by welding, a fixture, or the like, or may be manufactured by integrally molding at least a part of the parts constituting the module as one part by casting. Molding techniques for integrally molding one part, in particular a relatively large part, are also called gigacasts or megacasts. For example, the front module, the central module, and the rear module described above may be manufactured using gigacast.

(YY8) Transporting the vehicle 30 by using the traveling of the vehicle 30 by the unmanned driving is also referred to as “self-propelled conveyance”. A configuration for realizing self-propelled conveyance is also referred to as a “vehicle remote control autonomous traveling conveyance system”. Further, a production method of producing the vehicle 30 by using self-propelled conveyance is also referred to as “self-propelled production”. In self-propelled manufacturing, for example, at least a part of conveyance of the vehicle 30 is realized by self-propelled conveyance in a factory FC that manufactures the vehicle 30.

(YY9) In each of the above-described embodiments, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

Some or all of the processes in the above-described server 10 and ECU 33 can be implemented as a computer program. Such programs may be stored and provided to a computer using various types of non-transitory computer-readable media. Non-transitory computer-readable media include various types of tangible recording media (storage media). Exemplary non-transitory computer-readable media include magnetic recording media (e.g., flexible disks, magnetic tapes, hard disk drives), magneto-optical recording media (e.g., magneto-optical disks), CD-ROM, CD-R, CD-R/W, semiconductor memories (e.g., masking ROM, programmable ROM (PROM), erasable PROM (EPROM), flash ROM, and RAM). The program may also be supplied to the computer by various types of transitory computer readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

The present disclosure is not limited to the above embodiments but can be modified as appropriate within the scope of the gist of the disclosure.

What is claimed is:

1. A charge discharge management device, comprising:
an information acquisition unit that acquires production management information related to production of a vehicle, including at least one of a count of production units per predetermined time, and a shipping time limit, regarding the vehicle including a secondary battery; and
a charge discharge amount determining unit that determines a charge discharge amount per unit time of the secondary battery, based on the production management information.

2. The charge discharge management device according to claim 1, further comprising:
an allocation time determining unit that determines an allocation time allocated to charging and discharging of the secondary battery, using the production management information, wherein the charge discharge amount determining unit determines a charge discharge amount per unit time to the vehicle in accordance with the allocation time.

3. The charge discharge management device according to claim 1, wherein the charge discharge amount when the count of production units is a first count of units is greater than the charge discharge amount when the number of production units is a second count of units that is smaller than the first count of units.

4. The charge discharge management device according to claim 1, wherein the charge discharge amount when the shipping time limit is a first time limit is greater than the charge discharge amount when the shipping time limit is a second time limit that is longer than the first time limit.

5. A charge discharge system comprising:
a charge discharge management device including
an information acquisition unit that acquires production management information related to at least one of a count of production units per predetermined time, and a shipping time limit, regarding a vehicle including a secondary battery, and
a charge discharge amount determining unit that determines a charge discharge amount per unit time of the vehicle, based on the production management information; and
a charging discharging device that executes charging rate adjustment processing including at least one of charging processing for charging the secondary battery and discharging processing for discharging the secondary battery, according to the charge discharge amount.

6. The charge discharge system according to claim 5, wherein the charge discharge management device further includes an allocation time determining unit that determine an allocation time allocated to charging and discharging of the secondary battery, using the production management information, and
the charge discharge amount determining unit determines a charge discharge amount per unit time to the vehicle in accordance with the allocation time.

7. The charge discharge system according to claim 5, wherein the charge discharge amount when the count of production units is a first count of units is greater than the charge discharge amount when the count of production units is a second count of units that is smaller than the first count of units.

8. The charge discharge system according to claim 5, wherein the charge discharge amount when the shipping time limit is a first time limit is greater than the charge discharge amount when the shipping time limit is a second time limit that is longer than the first time limit.

9. The charge discharge system according to claim 5, wherein the charging and discharging device includes at least one of a contact-type charging discharging device and a non-contact-type charging discharging device.

10. The charge discharge system according to claim 5, wherein:
the charging discharging device includes a contact-type charging discharging device and a non-contact-type charging discharging device,
a charge discharge amount by the contact-type charging discharging device is equal for both when the count of production units is a first count of units and when the count of production units is a second count of units that is smaller than the first count of units, and also,
the charge discharge amount by the non-contact-type charging discharging device is greater when the count of production units is the first count of units than that when the count of production units is the second count of units.

11. A non-transitory storage medium storing a program causing a computer to execute:
processing of acquiring production management information related to at least one of a count of production units per predetermined time, and a shipping time limit, regarding a vehicle including a secondary battery; and
processing for determining a charge discharge amount per unit time to the vehicle, based on the production management information.
